(19) United States
(12) Patent Application Publication
(10) Pub. No.: US 2002/0011429 A1
(43) Pub. Date: Jan. 31, 2002

(54) Iron-containing crystalline aluminosilicate

(76) Inventors: Akira Iino, Sodegaura-shi (JP); Mitsuru Yoshita, Sodegaura-shi (JP); Kazuhiro Inamura, Sodegaura-shi (JP)

Correspondence Address: PARKHURST & WENDEL, L.L.P., 1421 Prince Street, Suite 210, Alexandria, VA, 22314-2805, US

(21) Appl. No.: 09/849,528

(22) Filed: May 7, 2001

Related U.S. Application Data
(63) Continuation-in-part of application No. 09/161,505, filed on Sep. 28, 1998, now abandoned.

(30) Foreign Application Priority Data
Sep. 30, 1997 (JP) 9-166558
Jul. 16, 1998 (JP) 10-202173

(51) Int. Cl. B01J 29/072; C10G 47/00

(52) U.S. Cl. 208/111.35; 423/716; 423/713; 502/74; 208/111.01

(57) ABSTRACT

An iron-containing crystalline aluminosilicate is provided which befits the incorporation as a component in a hydrocracking catalyst for hydrocarbon oil owing to the feature of exhibiting a highly satisfactory hydrocracking activity at no sacrifice of the yield of an middle distillate.

The inactive iron compound content [Fe] dep of this iron-containing crystalline aluminosilicate calculated by the temperature program reduction is not more than 25% and the reduction peak temperature Th (° C.) in at least one high temperature part is not lower than (−300×UD+8320) (wherein UD denotes the lattice constant () of the iron-containing crystalline aluminosilicate).

### BACKGROUND OF THE INVENTION

1. Field of the Invention

This invention relates to a novel iron-containing crystalline aluminosilicate, a method for the production thereof, and a method for the production of a hydrocracked oil by the use of a catalyst having the iron-containing crystalline aluminosilicate as an active component thereof.

2. Description of the Prior Art

In recent years, the crude oil used prevalently in the field of oil refinery is tending toward increasing involatility. The demand for petroleum products meanwhile is gradually tending inversely toward increasing volatility. In the circumstances, therefore, particularly the development of a technique capable of producing white oil of high quality from such heavy oils as atmospheric residue has become an important task. Further, as respects the vacuumed gas oil and the light cycle oil which have been heretofore refined under relatively mild conditions as compared with the atmosphere residue, their refineries are tending to have higher operational severity owing to the trend of their crude oils toward increasing involatility. This trend of the crude oils toward increasing involatility has been imposing aggravating difficulties on the refining technique which will require full removal of sulfur components and aromatic components from the feed oils in order to cope with the future environmental regulation. As the catalyst for hydrocracking of involatile hydrocarbons, therefore, the development of a zeolite (crystalline aluminosilicate) catalyst has been enthusiastically promoted.

Numerous species of zeolite catalyst have been proposed to date for cracking heavy oils and manufacturing such products of highly added value as, for example, light gas oil and gasoline. A catalyst containing a macroporous zeolite formed of aluminum-free faujasite zeolite (JP-A-58-147,495), a catalyst containing a macroporous zeolite and having a silica/alumina (molar ratio) of not less than 50 (JP-B-4-12,317), and a catalyst containing a low-acidity zeolite possessing a NH₃-TPD (temperature programmed desorption) acidity intensity of less than 2.00 (JP-B-6,55,951), for example, have been disclosed. These catalysts are aimed at controlling the strong acidity inherent in zeolite, restraining excess advance of hydrocracking, and exalting the capacity for increasing the production of an middle distillate. While they are effective in terms of the restrain of excessive hydrocracking, they are no fully satisfactory techniques for the purpose of increasing the production of an middle distillate because they are still capable of repressing hydrocracking. As means for simultaneously improving hydrocracking activity and exalting the yield of an middle distillate, iron-containing zeolite catalysts which are endowed with a high hidrocracking activity by utilizing the hydrogenating ability of iron have been proposed (JP-A-58-103,588, JP-A-59-92,026, JP-A-59-121,115, and JP-A-63-64,914). These iron-containing zeolite catalysts control the acidity of zeolite by effecting removal of aluminum from the skeleton of zeolite simultaneously with detergence of eliminated aluminum with a mineral acid or a low pH iron salt solution. Their skeletons, therefore, have a substantially lowered degree of crystallinity. Further, in this process, the hydrocracking ability is improved by supporting on the skeleton of zeolite the iron possessing the hydrogenating ability. This method of attaining the support of iron in a highly dispersed state by causing the removal of aluminum, however, accords only insufficient restrain of the degradation of acidity due to the obstruction caused by the deposited iron and allows no sufficient activation of the hydrocracking.

The possible causes for the formation of the deposit of iron on the iron-containing zeolite include the formation of hydrated iron oxide during the treatment with an iron salt solution and the phenomenon that the aluminum eliminated from steaming zeolite covers the surface of zeolite and the surface aluminum reacts with an iron salt and adapts itself for easy deposition of iron, for example. JP-B-6-74,135 discloses an iron-containing zeolite having the iron vested with an improved state by giving a wash with a mineral acid to the steaming zeolite. Though this iron-containing zeolite shows a fair effect of improvement as compared with the conventional iron-containing zeolite, it offers no sufficient hydrocracking activity because it is not sufficiently deprived of the deposited iron. It is further at a disadvantage in having an unduly high cost of production.

As means for simultaneously improving the hydrocracking activity and exalting the yield of an middle distillate, a steaming treatment, a treatment with a mineral acid, and the combination of these treatments are available. Methods for thoroughly rinsing exclusively the aluminum eliminated by these treatments are disclosed in JP-A-3-45,513 and JP-A-8-66,634. Since these methods substantially maintain the degree of crystallinity of the skeletal construction of zeolite, they allow only insufficient decrease in the amount of acid due to further elimination of aluminum from the skeleton and permit no ample increase in the yield of an middle distillate.

### SUMMARY OF THE INVENTION

This invention, motivated in view of the true state of prior art mentioned above, has the following three objects.

The primary object of this invention is to provide a novel iron-containing crystalline aluminosilicate befitting the incorporation as a component in the hydrocracking catalyst for a hydrocarbon oil by dint of the feature of possessing a high hydrocracking activity while maintaining the yield of an middle distillate.

Another object of this invention is to provide a method for the production of an iron-containing crystalline aluminosilicate which is capable of producing the iron-containing crystalline aluminosilicate of this invention conveniently and practically.

A further object of this invention is to provide a method which is capable of effecting the hydrocracking treatment of various hydrocarbon oils, heavy oils in particular, with high activity at no sacrifice of the yield of a middle distillate fraction by the use of a catalyst using the novel iron-containing crystalline aluminosilicate of this invention as a component thereof.

The present inventors, after continuing a diligent study with a view to fulfilling the objects mentioned above, have discovered an iron-containing crystalline aluminosilicate of this invention in consequence of the treatment of steaming crystalline aluminosilicate with a sulfuric acid salt of iron. The present invention has been perfected based on this knowledge.

Specifically, the essential points of this invention are as follows.

1. A method for the production of an iron-containing aluminosilicate satisfying the following conditions:

(A) the main composition of said aluminosilicate expressed in the form of oxides is represented by the formula

aFe₂O₃.Al₂O₃.bSiO₂.nH₂O (1)

wherein n is a real number of 1 to 30 and a and b are real numbers satisfying the relations

15≦b≦100, 0.005≦a/b≦0.15];

(B) an inactive iron compounded content (Fe) dep calculated by a temperature program reduction is not more than 25%;

(C) a reduction peak temperature Th in at least one high temperature part is in the range

Th>(−300×UD+8320)° C.

wherein UD is the lattice constant of said iron-containing crystalline aluminosilicate and is a real number within the range of 24.20 to 24.40, comprising:

subjecting a crystal aluminosilicate having a ratio of silica to alumina (molar ratio) of not less tarn 4.6 to a steaming treatment thereby obtaining steaming crystalline aluminosilicate having a crystallinity of at least 0.7, treating said steaming crystalline alumino-silicate with a mineral acid, and treating the resultant crystalline aluminosilicate with a sulfuric acid salt of iron in the presence of the mineral acid.

2. A method according to claim 1, wherein said mineral acid is sulfuric acid.

3. A hydrocracking catalyst for a hydrocarbon oil, having at least one of the metals of Groups 6, 8, 9, and 10 in he Periodic Table of the Elements supported on a carrier formed of 5-85 wt. % of an iron-containing crystalline aluminosilicate prepared in claim 1 and 95-15 wt. % of an inorganic oxide.

4. A catalyst according to claim 3, wherein said inorganic oxide is alumina and the metal supported on said carrier is molybdenum and nickel or cobalt.

5. A method for the production of a hydrocracking oil, which comprises subjecting a hydrocarbon oil to a hydrocracking using a hydrocracking catalyst set forth in claim 3.

6. A method according to claim 5, wherein said hydrocarbon oil subjected to said hydrocracking is a residual oil.

7. A method according to claim 5, wherein said hydrocarbon oil subjected to said hydrocracking is an heavy distillate.

### DESCRIPTION OF PREFERRED EMBODIMENT

Now, the mode of embodying this invention will be described below.

The novel iron-containing crystalline aluminosilicate of this invention is such that the main composition thereof expressed in the form of oxides is represented by the general formula [I] mentioned above. In this general formula, n denotes a real number of 1-30, b denotes a real number satisfying 15<b<100, preferably 18<b<45, and the relation of a and b satisfies 0.005<a/b<0.15, preferably 0.01<a/b<0.08. This iron-containing crystalline aluminosilicate may contain such alkali metal oxides as Na₂O and such alkaline earth metal oxide as CaO in a small amount.

Generally, iron compounds of such various forms as shown below are present in the iron-containing crystalline aluminosilicate.

(1) Inactive iron compounds which are simply adsorbed physically to the crystalline aluminosilicate. When such an iron compound is exposed to an atmosphere of hydrogen, it succumbs to the reduction of Fe³⁻→Fe⁰ in one step at temperatures of not higher than 500° C.

(2) Iron compounds which have interacted regularly with the skeleton of the crystalline aluminosilicate. These iron compounds occur in various forms, including ion-exchanged iron compounds, iron compounds forming the skeleton of crystalline aluminosilicate, and the novel iron compounds according to this invention. When such an iron compound is exposed to an atmosphere of hydrogen, it succumbs to two forms of reduction, one reduction of Fe³⁺→Fe²⁺ in the low temperature part (room temperature −700° C.) and the other reduction of Fe²⁺→Fe⁰ in the high temperature part (700-1200° C.)

The iron compounds of (1) can be discriminated by the inactive iron compound content [Fe] dep to be calculated by the determination of temperature program reduction (TPR) and the iron compound (2) can be discriminated by the high temperature reduction peak calculated by the determination of TPR.

The iron-containing crystalline aluminosilicate of this invention has a [Fe] dep of not more than 25%, preferably not more than 20%, as calculated by the determination of TPR mentioned above. It also has an at least one high temperature reduction peak temperature Th satisfying the formula

Th>(−300×UD+8320)° C.,

preferably the formula

Th>(−300×UD 30 8330)° C.

The term “TPR measurement” as used herein means the measurement of the amount of hydrogen consumed by a sample when the sample is heated to a rising temperature in a stream of hydrogen. The state of a metal in a sample can be easily known from the behavior of a relevant metal oxide during its reduction with hydrogen.

The reduction peaks generated in the TPR measurement by the iron-containing crystalline aluminosilicate of this invention are found to comprise a reduction peak of the low temperature part and a reduction peak of the high temperature part. Here, the peak of the reduction of Fe³⁺ to Fe²⁺ is recognized in the range of room temperature −700° C. as the reduction peak of the low temperature part and the peak of the reduction of Fe²⁺ to Fe⁰ is recognized in the range exceeding (−300×UD+8320)° C. as the reduction peak of the high temperature part. Heretofore, as described in JP-B-6-74,135, the reduction peak obtained in the high temperature part by the TPR measurement is held to fall in the range of 700-(−300×UD+8320)° C. Thus, the reduction peak in the high temperature part which is contemplated by this invention is shifted toward the higher temperature side. In the printed specification of the Japanese patent publication just mentioned, there is a mention to the effect that the reduction peak of a given iron-containing zeolite in the high temperature part is shifted toward the low temperature side in proportion as the zeolite gains in activity. Since the zeolite of the present invention differs in behavior from that of this patent, it is inferred that this invention has formed a novel iron compound. The symbol UD as used in this invention refers to the lattice constant of the crystals of the iron-containing crystalline aluminosilicate which falls in the range of 24.20-24.40

As respects the species of Fe in the iron-containing crystalline aluminosilicate of this invention, the ratio of the area of reduction peak of the high temperature part (high temperature peak area, Sh) (corresponding to the amount of hydrogen consumed in the high temperature part) to the area of reduction peak of the low temperature part (low temperature peak area, S1) (corresponding to the amount of hydrogen consumed in the low temperature part) ideally ought to be Sh/S1=2 as calculated from the valencies of the elements subjected to reduction. When the aluminosilicate suffers adulteration with an inactive (impure) iron compound, however, the ratio decreases below 2 because the reduction peak appeared in the low temperature part. The inactive iron compound content [Fe] dep, therefore, can be defined as follows.

[Fe] dep=(S1−Sh/2)/(S1+Sh)×100 (%)

The iron-containing crystalline aluminosilicate of the present invention, when rated by the scale of [Fe] dep, is not more than 25%, preferably not more than 20%.

The iron-containing aluminosilicate of this invention prefers the terminal SiOH group/Brønsted acid ratio measured in the infrared absorption spectrum (IR spectrum) to be in the range of 0.5-2. If this ratio is less than 0.5, the compound will assume an unduly strong acidic quality and, when used as a catalyst for the hydrocracking of a hydrocarbon oil, will tend to induce excessive cracking. Conversely, if this ratio is unduly large, the compound will assume an unduly weak acidic quality and will possibly suffer a decrease in the cracking ability. From the standpoint of adjusting the balance between the cracking ability and the restraint of excessive cracking, the ratio is particularly preferred to be in the range of 0.6-1.5.

The iron-containing crystalline aluminosilicate of this invention possesses various properties as mentioned above and contains iron in an utterly unprecedented form.

Then, the production of the iron-containing crystalline aluminosilicate of this invention is preferred to be carried out by method which will be described herein below. While the faujasite type zeolite, Y type zeolite, β zeolite, and the like are available as the raw material crystalline aluminosilicate, it is particularly proper to use the faujasite type zeolite whose ratio of silica to alumina (molar ratio), i.e. SiO₂/Al₂O₃, is not less than 3.5, preferably not less than 4.6, more preferably not less than 4.8. This crystalline aluminosilicate may have a Na₂O content of not more than about 2.4 wt. %, preferably not more than about 1.8 wt. %.

To begin with, the crystalline aluminosilicate answering the description given above is subjected to a steaming treatment to form a steaming crystalline aluminosilicate. Though the conditions for the steaming treatment may be properly selected to suit a varying situation, generally this treatment is carried out in the presence of steam of a temperature of 540-810° C. The steam may be introduced from the external source or it may be derived from the physically adsorbed water or the water of crystallization which is present in the zeolite. This crystalline aluminosilicate have a crystallinity of at least 0.7, Preferably 0.8. The crystallinity is defined as a relative X-ray peak intensity from Y-type zeolite measured by X-ray diffraction (XRD), where the crystallinity of a synthetic Na—Y zeolite (trade name SK-40, from UCC Co.) is of 1.0. If aluminosilicate have a crystallinity of less than 0.7, there increases coagulated iron and aluminium hydrate and iron hydrate are combined each other when treated with mineral acid (sulfuric acid) and with a sulfuric acid salt of iron, which results in failure to obtain a suitable iron aluminosilicate without coagulated-materials. In addition, such low crystalline aluminosilicate is damaged to its framework after treatment with a sulfuric acid salt of iron and a sulfuric acid. As a result, the obtained iron aluminosilicate does not show a higher catalytic activity. The steaming crystalline aluminosilicate consequently formed is converted into a slurry state with added water.

Then, the steaming crystalline aluminosilicate obtained by the steaming treatment described above and a mineral acid added thereto are mixed by a stirring treatment to remove aluminum from the skeleton of zeolite structure and rid the zeolite of the loose aluminum. Among other various mineral acids which may be cited, hydrochloric acid, nitric acid, and sulfuric acid are particularly popularly used. Besides, such inorganic acids as phosphoric acid, perchloric acid, peroxidisulfonic acid, thionic acid, sulfamic acid, and nitrososulfonic acid and such organic acids as formic acid, trichloroacetic acid, and trifluoroacetic acid are also usable. The amount of the mineral acid to be added is in the range of 0.5-15 mols, preferably 3-11 mols, per kg of the crystalline aluminosilicate. The mineral acid concentration is in the range of 0.5-50 wt. %, preferably 1-20 wt. %, based on the weight of the solution containing the mineral acid. The temperature of the treatment is in the range of room temperature −100° C., preferably 50-100° C. and the duration of the treatment is in the range of 0.1-12 hours.

Subsequently, the resultant reaction system is mixed by a stirring treatment with a sulfuric acid salt of iron to effect support of iron on the zeolite, removal of aluminum from the skeleton of zeolite structure, and expulsion of loose aluminum. Though the conditions for the treatment with the sulfuric acid salt of iron are variable with the prevalent situation and cannot be decided indiscriminately, it is generally proper to select the temperature of treatment in the range of 30-100° C., preferably 50-80° C., the duration of treatment in the range of 0.1-12 hours, preferably 0.5-5 hours, and the pH value of not more than 2.0, preferably not more than 1.5. While ferrous sulfate and ferric sulfate may be cited as the concrete sulfuric acid salt of iron, ferric sulfate proves particularly favorable. Though the sulfuric acid salt of iron may be added in its unmodified form, it is preferably added in the form of a solution. Though the solute to be used for the solution is only required to be capable of solving the iron salt, water, alcohol, ether, or ketone is preferably used. The concentration of the sulfuric acid salt of iron in the solution is generally in the range of 0.02-10.0 mols/liter, preferably in the range of 0.05-5.0 mols/liter.

In the treatment of the crystalline aluminosilicate with the mineral acid and the sulfuric acid salt of iron, the slurry ratio, namely the ratio of the volume of the solution engaging in the treatment (liter)/weight of aluminosilicate (kg), is advantageous in the range of 1-50, particularly 5-30.

It is inferred that by simultaneously removing aluminum from the crystalline aluminosilicate in a low pH range and supporting of iron on the crystalline aluminosilicate by usage of surface acid salt in accordance with the method of production of this invention, the crystalline aluminosilicate is enabled to function effectively for controlling the acidic quality thereof, acquiring an ability of hydrogenation due to fine division of iron, and manifesting an exalted ability of cracking.

The iron-containing crystalline aluminosilicate obtained as described above, when necessary, is properly washed with water, dried, and calcined. Preferably, this additional treatment is performed to the step of drying the washed product to the extent of ensuring easy conveyance.

To serve satisfactorily as the raw material for the manufacture of an efficient catalyst for the hydrocracking of an heavy oil, the produced iron-containing crystalline aluminosilicate is preferred to have a pore diameter distribution such that the volume of pores having pore diameters in the range of 50-300 accounts for 15-45% of the total volume of pores having pore diameters of not more than 600 and the volume of pores having pore diameters in the range of 100-300 accounts for 5-35% of the total volume of pores having pore diameters of not more than 600. If the volume is smaller than the lower limit of the range mentioned, the activity of hydrogecracking will be unduly low and the yield of a middle distillate will be also unduly low. If this volume is larger than the upper limit of the range, the zeolite will no longer be able to maintain crystallinity and will cease to manifest the hydrocracking function inherent therein. For the same token, it is preferable that the volume of pores having pore diameters in the range of 50-300 accounts for 20-40% of the total volume of pores having pore diameters of not more than 600 and the volume of pores having pore diameter in the range of 100-300 accounts for 10-30% of the total volume of pores having pore diameters of not more than 600. The numerical values of the pore diameter distribution reported herein have been determined by the BJH method utilizing the phenomenon of nitrogen gas adsorption.

The carrier for the catalyst which is used in the method for the hydrocracking of a hydrocarbon oil according to this invention is composed of 5-85 wt. % of the iron-containing crystalline aluminosilicate mentioned above and 95-15 wt. % of an inorganic oxide. The appropriate ratio of the two components varies with the kind of hydrocarbon oil to be used as the feed oil for the treatment. When such an heavy residual oil as vacuum reside or atmospheric reside is used as the feed oil for the treatment, for example, the proportion of the iron-containing crystalline aluminosilicate is properly in the range of 20-75 wt. %, and more properly in the range of 45-70 wt. %. When a vacuum gas oil or an heavy gas oil is used as the fed oil, the proportion of the iron-containing crystalline aluminosilicate is properly in the range of 5-60 wt. %, and more properly in the range of 5-40 wt. %.

The inorganic oxide mentioned above is such a porous and amorphous inorganic oxide as is generally used for catalytic cracking. Hydrated oxides such as, for example, boehmite gel, alumina sol and other similar alumina compounds, silica sol and other similar silica compounds, silica-lumina, and polyalumina are usable as the inorganic oxide. If the proportion of the ion-containing aluminosilicate is unduly small, the reaction temperature required for the production of a middle distillate aimed at will be so high as to bring about an adverse effect on the life cycle of the catalyst. If the proportion of the ion-containing aluminosilicate is unduly large, while the hydrocracking activity is exalted, the hydrocracking will proceed excessively to produce naphtha and gas in large amounts and lower the selectivity of a middle distillate.

The composition formed of the iron-containing crystalline aluminosilicate and the inorganic oxide as mentioned above is dried at a temperature in the range of 30-200° C. for a period in the range of 0.1-24 hours and then calcined at a temperature in the range of 300-750° C. (preferably 450-700° C.)for a period in the range of 1-10 hours (preferably 2-7 hours) to produce the carrier.

The metal component to be supported on this carrier is at least one of the metals of Groups 6, 8, 9, and 10 in the Periodic Table of the Elements. Among other metals belonging to Group 6 in the Periodic Table of the Elements, Mo and W prove particularly advantageous. Among other metals belonging to Groups 8-10, Ni, Co, and Fe prove particularly advantageous. As concrete examples of the combination of two metals, Ni—Mo, Co—Mo, Ni—W, and Co—W may be cited. Among other combinations cited above, Co—Mo and Ni—Mo prove particularly advantageous. The amount of the metal supported as the active component mentioned above is not particularly discriminated but may be properly selected depending on various pertinent conditions. Generally, the amount of the metal of Group 6 is in the range of 0.5-24 wt. %, preferably 5-18 wt. %, based on the total amount of the catalyst and the amount of the metal of Groups 8-10 is in the range of 0.1-20 wt. %, preferably 1-8 wt. %, based on the total amount of the catalyst.

For the support of the active component on the carrier, any of the known methods such as, for example, method of impregnation, method of kneading, and method of coprecipitation may be employed.

The composite resulting from the support of the active component mentioned above on the carrier is dried at a temperature in the range of 30-200° C. for a period in the range of 0.1-24 hours and then calcined at a temperature in the range of 300-750° C. (preferably 450-700° C.) for a period in the range of 1-10 hours (preferably 2-7 hours) to finish a catalyst.

As concerns the physical properties of the catalyst resulting from the support of the metal as an active component on the carrier, the surface area (BET method) is in the range of 100-600 m²/g, preferably 150-500 m²/g, the pore volume (determined by the mercury injection method when the catalyst is used for a residual oil or the nitrogen adsorption method when the catalyst is used for a distillate oil) is in the range of 0.20-0.80 cc/g, preferably 0.30-0.60 cc/g, and the average pore diameter (determined by the mercury injection method when the catalyst is used for a residual oil or the nitrogen adsorption method when the catalyst is used for a distillate oil) is in the range of 70-200, preferably 70-180. When the mercury injection method is adopted where such an heavy residual oil as atmospheric residue or vacuum residue is used as the feed oil, the volume of pores having pore diameters exceeding 1,000 is preferred to exceed 0.1 cc/g.

The production of hydrocracked oil in consequence of the hydrocracking of a hydrocarbon oil according to the present invention is accomplished by subjecting the hydrocarbon oil to the hydrocracking using the catalyst mentioned above. The hydrocarbon oil to be used as the feed oil for the hydrocracking herein is not particularly discriminated but may be selected arbitrarily from among various species of hydrocarbon oil. As concrete examples of the feed oil particularly advantageously used herein, such hydrocarbon oils as atmospheric residue, vacuum residue, raffinate of solvent deasphalting, clarified oil, visbreaking oil, crude oil, and topped crude which entrain residues (collectively referred to as “residual oils”), such heavy distillate as heavy gas oil, vacuum gas oil, light cycle oil, coker gas oil, and solvent deasphalted oil, and mixed oils containing the oils enumerated above may be cited. Other hydrocarbon oils usable as the feed oil include coal tar, tar sand oil, and shale oil.

In the hydrocracking of a hydrocarbon oil in accordance with the method of production contemplated by this invention, the reaction conditions to be adopted may be selected from a wide range of reaction conditions heretofore employed for a hydrocracking. Though the reaction conditions vary with the kind of feed oil and cannot be indiscriminately fixed, it is generally proper to select the reaction temperature in the range of 320-550° C., preferably 350-430° C., the hydrogen partial pressure in the range of 10-300 kg/cm², preferably 50-150 kg/cm², the hydrogen/oil (ratio) in the range of 100-1000 nm³/kl, preferably 300-1000 nm³/kl, and the liquid hourly space velocity (LHSV) in the range of 0.1-5 h⁻¹, preferably 0.2-2.0 h⁻¹.

Generally, when the residual oil is treated to obtain a hydrocracking oil for the purpose of producing naphtha and kerosene, the hydrocracking is carried out more often than not to the extent of obtaining a yield of 30-80%. If the ratio of cracking is raised to an unduly high level, the gas will be generated excessively and the catalyst will suffer unduly early deactivation. Even when the ratio of cracking is raised so as to approximate closely to 100% in the treatment of the heavy oil for the production of a hydrocracking oil, the treatment generates a gas in a smaller amount than in the treatment of the residual oil and the product of the treatment can be utilized in a higher yield for the production of naphtha and kerosene. Further, by recycling part of the product oil to the hydrocracking, the generation of gas can be restrained and the deactivation of the catalyst can be precluded in spite of an increase in the ratio of cracking.

Further, the method for the hydrocracking of this invention may use the catalyst of this invention, either alone or in combination with an ordinary catalyst for hydrotreating catalyst.

Now, this invention will be described more specifically below by reference to working examples. It should be noted, however, that this invention is not limited in any way by these working examples.

### EXAMPLE 1

### (1) Preparation of iron-containing crystalline aluminosilicate

A synthetic Na—Y zeolite (Na₂O content 13.3 wt. %, SiO₂/Al₃O₃ mol ratio 5.0) was subjected to ammonium exchange to obtain NH₄-Y zeolite (Na₂O content 1.3 wt. %). This product was subjected to a steaming treatment at 580° C. to obtain steaming zeolite. The crystallinity of thus obtained steaming zeolite was of 0.85. Ten (10) kg of the steaming zeolite was suspended on 115 liters of purified water and the resultant suspension was heated to 75° C. and stirred for 30 minutes. Then, the suspension, 63.7 kg of an aqueous 10 wt. % sulfuric acid solution which was added thereto over a period of 35 minutes, and 11.5 kg of an aqueous solution containing ferric sulfate at a concentration of 0.57 mol/liter which was further added thereto over a period of 10 minutes were altogether stirred for 30 minutes, subsequently filtered, and washed to obtain an iron-containing crystalline aluminosilicate slurry I having a solids concentration of 30.5 wt. %.

Part of the iron-containing crystalline aluminosilicate slurry I was extracted and dried and then tested for pore construction. Consequently, the volume of pores having pore diameters of not more than 600 was found to be 0.5393 cc/g, the ratio of the volume of pores having pore diameters of not more than 600 C to the volume of pores having pore diameters in the range of 50-300 to be 22.8%, and the proportion of the volume of pores having pore diameters in the range of 100-300 to be 15.6%.

### (2) Preparation of alumina slurry

In a stainless steel vessel having an inner volume of 200 liters and provided with a steam jacket, 80 kg of an aqueous sodium aluminate solution (having a concentration of 5.0 wt. % as Al₂O₃) and 240 g of an aqueous 50 wt. % gluconic acid solution were placed and heated to 60° C. Then, 88 kg of a dilute aqueous aluminum sulfate solution (having a concentration of 2.5 wt. % as Al₂O₃) prepared in a separate vessel was added to the nascent hot mixture over a period of 15 minutes till pH 7.2 to give rise to an aluminum hyroxide slurry (prepared slurry I). The prepared slurry I was kept at 60° C. and meanwhile left aging for 60 minutes. Then, the prepared slurry was in its whole volume dehydrated with a planar filter and washed with 600 liters of 0.3 wt. % aqua ammonia at 60° C. to obtain an alumina cake. By combining part of the alumina cake with purified water and a 15 wt. % aqua ammonia, a slurry having an alumina concentration of 12.0 wt. % and pH 10.5 was obtained. In a stainless steel aging tank fitted with a refluxing device, the slurry was stirred and meanwhile left aging at 95° C. for eight hours. Then, the aged slurry was diluted with added purified water to an alumina concentration of 9.0 wt. %, transferred into an autoclave fitted with a stirrer, and left aging at 145° C. for five hours. The slurry was further thermally concentrated till 20 wt. % as Al₂O₃ and simultaneously deprived of ammonia to obtain an alumina slurry A.

### (3) Preparation of catalyst

In a kneader, 3200 g of the iron-containing crystalline aluminosilicate slurry I (concentration 30.5 wt. %) and 2625 g of the alumina slurry A (concentration 20 wt. %) were placed, heated and stirred till a concentration fit for extrusion molding, and then extrusion molded into pellets of a trilobe, 1/16 inch in size. The pellets were then dried at 110° C. for 16 hours and then calcined at 550° C. for three hours to obtain a carrier I of Example 1 having an iron-containing crystalline aluminosilicate/alumina (weight ratio as solids) of 65/35.

Subsequently, a suspension of molybdenum trioxide and cobalt carbonate in purified water was heated to 90° C. and malic acid was added to and solved in the hot suspension. The carrier I was impregnated with the resultant solution till a concentration of 10.0 wt. % as MoO₃ and a concentration of 4.25 wt. % as CoO. The wet carrier was dried and calcined at 550° C. for three hours to obtain a catalyst I. This catalyst was found to have a specific surface area of 455 m²/g, a pore volume of 0.62 cc/g, and a volume of 0.13 cc/g of pores having pore diameters of not less than 1,000. In Examples 1-3 and Comparative Examples 1 and 2, the specific surface area was determined by the BET method and the pore diameter distribution by the mercury injection method.

### EXAMPLE 2

A carrier II was obtained by following the procedure of (3) of Example 1 while changing the iron-containing crystalline aluminosilicate/alumina ratio (weight ratio as solids) to 60/40 and a catalyst II was similarly obtained by impregnating the carrier II with a solution of metals. This catalyst II was found to have a specific surface area of 463 m²/g, a pore volume of 0.63 cc/g, and a volume of 0.13 cc/g of pores having pore diameters of not less than 1,000 (determined in the same manner as the catalyst I).

### EXAMPLE 3

A carrier III was obtained by following the procedure of (3) of Example 1 while changing the iron-containing crystalline aluminosilicate/alumina ratio (weight ratio as solids) to 10/90. Further a catalyst III was obtained by following the procedure of (3) of Example 1 while changing cobalt carbonate to nickel carbonate and impregnating the carrier with metals till a concentration of 4.25 wt. % as NiO and a concentration of 15.0 wt. % as MoO₃. This catalyst III was usable for the hydrocracking of such feed oil as vacuum gas oil, heavy gas oil, and coker gas oil.

### EXAMPLE 4

### (1) Preparation of iron-containing crystalline aluminosilicate

An iron-containing crystalline aluminosilicate I was prepared by following the procedure of (1) of Example 1.

### (2) Preparation of alumina slurry

Alumina seeds were produced by placing 100 kg of the prepared slurry obtained in (2) of Example 1 in a tank provided with a stirrer and an external circulating line and keeping the slurry at 60° C. and meanwhile stirring by external circulation at 10 m³/hr for 30 minutes. Then a prepared slurry II was obtained by continuing the external circulation without a change and simultaneously adding an aqueous sodium aluminate solution (having a concentration of 5 wt. % as Al₂O₃) and an aqueous aluminum sulfate solution (having a concentration of 2.5 wt. % as Al₂O₃) at respective rates of 150 kg/hr and 160 kg/hr for three hours. The amount of the aqueous aluminum sulfate to be added was adjusted so that the pH in the tank remained constantly at 7.0-7.5. Three (3) kg of the prepared slurry II (as alumina) was dehydrated with a planar filter and washed with 300 liters of aqua ammonia (concentration 0.3 wt. %) at 60° C. The washed cake was combined with deionized water and aqua ammonia (concentration 15 wt. %) to form a slurry of pH 10.5 (having a concentration of 19 wt. % as alumina) . The slurry was stirred and aged at 95° C. for 30 minutes to obtain an alumina slurry B.

### (3) Preparation of catalyst

The iron-containing crystalline aluminosilicate slurry I and the alumina slurry B were introduced into a kneader at a weight ratio of 10/90 as solids. They were heated and stirred therein till a concentration fit for extrusion molding and then molded with an extrusion molder to form cylindrical pallets, 1/16 inch in size. The pellets were then dried at 110° C. for 16 hours and subsequently calcined at 550° C. for three hours to obtain a carrier IV.

A catalyst IV was obtained by following the procedure of (3) of Example 1 while changing cobalt carbonate to nickel carbonate and impregnating the carrier with metals till a concentration of 4.25 wt. % as NiO and 15.0 wt. % as MoO₃. This catalyst was found to have a specific surface area of 275 m²/g, a pore volume of 0.58 cc/g, and an average pore diameter of 104. In Examples 4 and 5 and Comparative Examples 3 and 4, the specific surface area was determined by the BET method and the pore volume and the pore diameter distribution were determined by the nitrogen adsorption method.

### EXAMPLE 5

A carrier V was produced by following the procedure of Example 4 while adjusting the weight ratio of the iron-containing crystalline aluminosilicate slurry I and the alumina slurry B to 15/85 as solids and a catalyst V was obtained by following the procedure of Example 4 while calcining this carrier V in an atmosphere allowing the presence of steam at 650° C. for three hours. This catalyst was found to have a specific surface area of 221 m²/g, a pore volume of 0.51 cc/g, and an average pore diameter of 115 (determined by the same method as the catalyst IV).

### EXAMPLE 6

### (1) Preparation of iron-containing crystalline aluminosilicate

The iron-containing crystalline aluminosilicate I was prepared by following the procedure of (1) of Example 1.

### (2) Preparation of alumina slurry D

In a stainless steel vessel having an inner volume of 200 liters and provided with a steam jacket, 80 kg of an aqueous sodium aluminate solution (having a concentration of 5.0 wt. % as Al₂O₃) and 240 g of an aqueous 50 wt. % gluconic acid solution were placed and heated to 60° C. Then, 88 kg of an aqueous aluminum sulfate solution (having a concentration of 2.5 wt. % as Al₂O₃) adjusted to pH 7.2 was added to the hot mixture over a period of 15 minutes to obtain an aluminum slurry (prepared slurry).

The prepared slurry was dehydrated with a planar filter and washed with a 0.3 wt. % aqua ammonia at 60° C. to obtain a washed alumina cake.

The washed alumina cake was combined with a 15 wt. % aqua ammonia and purified water to obtain a slurry having a solids concentration of 12 wt. % (as Al₂O₃) and a pH 10.5. This slurry was stirred in a stainless steel aging tank fitted with a refluxing device and meanwhile left aging at 95° C. for eight hours. The aged slurry was concentrated thermally to effect removal of ammonia and expulsion of the water component and obtain an alumina slurry D having a solids concentration of 20 wt. % (as Al₂O₃).

### (3) Preparation of catalyst

The alumina slurry D and boric acid were combined in amounts calculated to form a weight ratio, Al₂O₃/B₂O₃, of 85/15 to obtain an alumina-boric acid slurry.

This alumina-boric acid slurry and the iron-containing crystalline aluminosilicate slurry I were introduced into a kneader in amounts calculated to form a solids weight ratio of 90/10, heated and simultaneously stirred therein till a concentration fit for extrusion molding, and subsequently formed with an extrusion molder furnished with dies, 1.8 mm in diameter, to obtain cylindrical pellets. Then, the pellets were dried at 110° C. for 12 hours and subsequently calcined at 550° C. for three hours to obtain a carrier X.

A catalyst X was obtained by following the procedure of (3) of Example 1 while changing cobalt carbonate to nickel carbonate and impregnating the carrier X with metals till a concentration of 4.25 wt. % as NiO and a concentration of 15.0 wt. % as MoO₃. This catalyst X was found to have an average pore diameter of 71, a specific surface area of 275 m²/g, and a pore volume of 0.40 cc/g (determined by the same method as in Example 4).

### EXAMPLE 7

### (1) preparation of iron-containing crystalline aluminosilicate

The iron-containing crystalline aluminosilicate I was prepared in the same manner as in (1) of Example 1.

### ((3) Preparation of catalyst

A carrier XI was obtained by following the procedure of Example 6 while combining the alumina-boric acid slurry and the iron-containing crystalline aluminosilicate slurry I in amounts calculated to form a solids weight ratio of 85/15. This carrier XI was impregnated with metals in the same manner as in Example 6. The impregnated carrier was calcined at 550° C. to obtain a catalyst XI. This catalyst XI was found to have an average pore diameter of 69, a specific surface area of 288 m²/g, and a pore volume of 0.37 cc/g (determined by the same method as in Example 4).

### EXAMPLE 8

### (1) Preparation of iron-containing crystalline aluminosilicate

The iron-containing crystalline aluminosilicate I was prepared in the same manner as in (1) of Example 1.

### (2) Preparation of alumina slurry E

In a stainless steel vessel having an inner volume of 200 liters and provided with a steam jacket, 80 kg of an aqueous sodium aluminate solution (having a concentration of 5.0 wt. % as Al₂O₃) and 240 g of an aqueous 50 wt. % gluconic acid solution were placed and heated herein to 60° C. Then, 88 kg of an aqueous aluminum sulfate solution (having a concentration of 2.5 wt. % as Al₂O₃) adjusted to pH 7.2 was added to the hot solution over a period of 15 minutes to obtain an aluminum slurry (prepared slurry) E.

This prepared slurry was dehydrated with a planar filter and washed with a 0.3 wt. % aqua ammonia at 60° C. to obtain a washed alumina cake.

This washed alumina cake was combined with silica colloid (having a concentration of 20.5 wt. % as SiO₂, made by Shokubai Kasei Kogyo K.K. and sold under the trademark designation of “Cataloid Sl-30”), a 15 wt. % aqua ammonia, and purified water to obtain a slurry having a solids concentration of 12 wt. % (as Al₂O₃ +SiO₂) and a pH of 10.5. This slurry had a weight ratio, Al₂O₃/SiO₂) of 90/10. In a stainless steel aging tank fitted with a refluxing device, the slurry was stirred and simultaneously left aging at 95° C. for eight hours, and then thermally concentrated to effect removal of ammonia and expulsion of part of the water component and obtain an alumina silica slurry (called “alumina slurry E”) having a solids concentration of 20 wt. % (as Al₂O₃+SiO₂).

### (3) Preparation of catalyst

The alumina slurry E and the iron-containing crystalline aluminosilicate slurry I were introduced into a kneader in amounts calculated to form a solids weight ratio of 15/85, heated and simultaneously stirred therein till a concentration fit for extrusion molding, and subsequently formed with an extrusion molder furnished with dies, 1.8 mm in diameter, to obtain cylindrical pellets. Then, the pellets were dried at 110° C. for 12 hours and subsequently calcined at 650° C. in the presence of steam for three hours to obtain a carrier XII.

This carrier XII was impregnated with metals by following the procedure of Example 6 while changing cobalt carbonate to nickel carbonate and impregnating the carrier with metals till a concentration of 4.25 wt. % as NiO and a concentration of 15.0 wt. % as MoO₂. The impregnated carrier was calcined at 550° C. to obtain a catalyst XII. This catalyst XII was found to have an average pore diameter of 70, a specific surface area of 303 m²/g, and a pore volume of 0.44 cc/g (determined by the same method as Example 4).

### EXAMPLE 9

A carrier XIII was obtained by following the procedure of (3) of Example 1 while changing the weight ratio of the iron-containing crystalline aluminosilicate/alumina to 55/45 as solids. This catalyst was found to have a specific surface area of 403 m²/g, a pore volume of 0.60 cc/g, and a volume of 0.10 cc/g of pores having pore diameters of not less than 1,000 (determined by the same method as the catalyst I).

### EXAMPLE 10

### (1) Preparation of iron-containing crystalline aluminosilicate

A synthetic Na—Y zeolite (Na₂O content 13.3 wt. %, SiO₂/Al₃O₃ mol ratio 5.0) was subjected to ammonium exchange to obtain NH₄-Y zeolite (Na₂O content 1.3 wt. %). This product was subjected to a steaming treatment at 580° C. to obtain steaming zeolite. Ten (10) kg of the steaming zeolite was suspended on 115 liters of purified water and the resultant suspension was heated to 75° C. and stirred for 30 minutes. Then, the suspension, 53.9 kg of an aqueous 10 wt. % sulfuric acid solution which was added thereto over a period of 35 minutes, and 11.5 kg of an aqueous solution containing ferric sulfate at a concentration of 0.57 mol/liter which was further added thereto over a period of 10 minutes were altogether stirred for 30 minutes, subsequently filtered, and washed to obtain an iron-containing crystalline aluminosilicate slurry IV having a solids concentration of 30.5 wt. %.

This iron-containing crystalline aluminosilicate slurry IV was found to have a lattice constant of 24.38, an iron content of 4.8 wt. % (as Fe₂O₃), a SiO₂/Al₂O₃ mol ratio of 24.7, and a specific surface area of 751 m²/g.

### (2) Preparation of catalyst

A carrier XIV and a catalyst XIV were obtained by following the procedure of (3) of Example 1 while using the iron-containing crystalline aluminosilicate slurry IV mentioned above and the alumina slurry A obtained in (2) of Example 1 in amounts calculated to form a weight ratio of 55/45 (as solids). This catalyst XIV was found to have a specific surface area of 416 m²/g, a pore volume of 0.66 cc/g, and a volume of 0.13 cc/g of pores having pore diameters of not less than 1,000. The specific surface area was determined by the BET method and the pore volume and the pore diameter distribution were determined by the mercury injection method.

### COMPARATIVE EXAMPLE 1

### (1) Preparation of iron-containing crystalline aluminosilicate

A synthetic Na—Y zeolite (Na₂O content 13.3 wt. %, SiO₂/Al₂O₃ mol ratio 5.0) was subjected to ammonium exchange to obtain NH₄-Y zeolite (Na₂O content 1.3 wt. %). This product was subjected to a steaming treatment at 580° C. to obtain steaming zeolite. The crystallinity of thus obtained streaming zeolite was of 0.85. Ten (10) kg of the steaming zeolite was suspended on 115 liters of purified water and the resultant suspension was heated to 75° C. and stirred for 30 minutes. Then, the suspension, 81.9 kg of an aqueous 10 wt. % nitric acid solution which was added thereto over a period of 35 minutes, and 23.0 kg of an aqueous solution containing ferric nitrate at a concentration of 0.57 mol/liter which was further added thereto over a period of 10 minutes were altogether stirred for 30 minutes, subsequently filtered, and washed to obtain an iron-containing crystalline aluminosilicate slurry II having a solids concentration of 30.5 wt. %.

### (2) Preparation of alumina slurry

This step was performed in the same manner as in Example 1.

### (3) Preparation of catalyst

In a kneader, 3200 g of the iron-containing crystalline aluminosilicate slurry II (concentration 30.5 wt. %) and 2625 g of the alumina slurry A (concentration 20 wt. %) were placed, heated and stirred till a concentration fit for extrusion molding, and then extrusion molded into pellets of trilobe, 1/16 inch in size. The pellets were then dried at 110° C. for 16 hours and then calcined at 550° C. for three hours to obtain a carrier VI having an iron-containing crystalline aluminosilicate/alumina weight ratio of 65/35 (as solids).

Subsequently, a suspension of molybdenum trioxide and cobalt carbonate in purified water was heated to 90° C. and malic acid was added to and solved in the hot suspension. The carrier VI was impregnated with the resultant solution till a concentration of 10.0 wt. % as MoO₃ and a concentration of 4.25 wt. % as CoO based on the whole amount of the catalyst. The wet carrier was dried and calcined at 550° C. for three hours to obtain a catalyst VI. This catalyst was found to have a specific surface area of 455 m²/g, a pore volume of 0.62 cc/g, and a volume of 0.13 cc/g of pores having pore diameters of not less than 1,000 (determined in the same manner as the catalyst I).

### COMPARATIVE EXAMPLE 2

### (1) Preparation of iron-containing crystalline aluminosilicate

A synthetic Na—Y zeolite (Na₂O content 13.3 wt. %, SiO₂/Al₂O₃ mol ratio 5.0) was subjected to ammonium exchange to obtain NH₄-Y zeolite (Na₂O content 1.3 wt. %). This product was subjected to a steaming treatment at 580° C. to obtain steaming zeolite. The crystallinity of thus obtained steaming zeolite was of 0.85. Ten (10) kg of the steaming zeolite was suspended on 200 liters of purified water. The resultant suspension and 46.1 kg of an aqueous ferric nitrate solution having a concentration of 0.57 mol/liter, which was added thereto over a period of 10 minutes, were together stirred for five minutes. The resultant suspension was heated from room temperature to 75° C. over a period of 35 minutes. At the time that the temperature of the suspension in the course of the temperature elevation reached 60° C., 41.0 kg of an aqueous 10 wt. % nitric acid solution was added to the suspension over a period of 35 minutes. Then, the suspension was stirred for 30 minutes, filtered, washed, and dried at 120° C. for four hours to obtain an iron-containing crystalline aluminosilicate III having a solids concentration of 52.3 wt. %.

### (2) Preparation of alumina slurry

In a stainless steel vessel having an inner volume of 200 liters and provided with a steam jacket, 80 kg of an aqueous sodium aluminate solution (having a concentration of 5.0 wt. % as Al₂O₃) and 240 g of an aqueous 50 wt. % gluconic acid solution were placed and heated to 60° C. Then, 88 kg of a dilute aqueous aluminum sulfate solution (having a concentration of 2.5 wt. % as Al₂O₃) prepared in a separate vessel was added to the nascent hot mixture over a period of 15 minutes till pH 7.2 to give rise to an aluminum hyroxide slurry (prepared slurry I). The prepared slurry I was kept at 60° C. and meanwhile left aging for 60 minutes. Then, the prepared slurry was in its whole volume dehydrated with a planar filter and washed with 600 liters of 0.3 wt. % aqua ammonia at 60° C. to obtain an alumina cake. By combining part of the alumina cake with purified water and a 15 wt. % aqua ammonia, a slurry having an alumina concentration of 12.0 wt. % and pH 10.5 was obtained. In a stainless steel aging tank fitted with a refluxing device, the slurry was stirred and meanwhile left aging at 95° C. for eight hours. Then, the aged slurry was thermally concentrated to a level of 20 wt. % as Al₂O₃ to effect removal of ammonia and formation of an alumina slurry C.

### (3) Preparation of catalyst

A carrier VII formed of an iron-containing aluminosilicate and alumina at a weight ratio (as solids) of 65/35 was obtained by intimately kneading 746 g of the iron-containing crystalline aluminosilicate III (having a concentration of 52.3 wt. %) and 600 g of the alumina slurry C (having a concentration of 35 wt. %), then extrusion molding the resultant mixture, drying the extrude with dry air at 200° C. for four hours, and calcining the dried extrude in a rotary kiln at 550° C. for three hours.

Subsequently, a suspension of molybdenum trioxide and cobalt carbonate in purified water was heated to 90° C. and malic acid was added to and solved in the hot suspension. The carrier VII was impregnated with the resultant solution till a concentration of 10.0 wt. % as MoO₃ and a concentration of 4.25 wt. % as CoO respectively based on the total amount of the catalyst. The wet carrier was dried by means of a rotary kiln and calcined at 550° C. for three hours to obtain a catalyst VII. This catalyst was found to have a specific surface area of 435 m²/g, a pore volume of 0.62 cc/g, and a volume of 0.13 cc/g of pores having pore diameters of not less than 1,000 (determined in the same manner as the catalyst I).

### COMPARATIVE EXAMPLE 3

A catalyst VIII was prepared by following the procedure of Example 4 while preparing a carrier VIII by using the iron-containing crystalline aluminosilicate slurry II in the place of the iron-containing crystalline aluminosilicate slurry I. This catalyst was found to have a specific surface area of 244 m²/g, a pore volume of 0.59 cc/g, and a pore diameter of 139 (determined in the same manner as in Example 4).

### COMPARATIVE EXAMPLE 4

A catalyst IX was prepared by following the procedure of Comparative Example 3 while performing the calcination for the preparation of a carrier IX in an atmosphere permitting the presence of steam at 650° C. for three hours. This catalyst was found to have a specific surface area of 179 m²/g, a pore volume of 0.54 cc/g, and a pore diameter of 137 (determined in the same manner as in Example 4).

### COMPARATIVE EXAMPLE 5

### (1) Preparation of iron-containing crystalline aluminosilicate

A synthetic Na—Y zeolite (Na₂O content 13.0 wt. %, SiO₂/Al₂O₃ mol ratio 4.7) was subjected to ammonium exchange to obtain NH₄-Y zeolite (Na₂O contents 1.25 wt. %). This product was subjected to a steaming treatment at 580° C. to obtain steaming zeolite. The crystallinity of thus obtained steaming zeolite was of 0.65. By using thus obtained steaming zeolite, the iron-containing crystalline aluminosilicate IV was prepared by following the procedure of (1) of Example

### (2) Preparation of alumina slurry

This step was performed in the same manner as in Example 1 to obtain alumina slurry A.

### (3) Preparation of catalyst

By using the iron-containing crystalline aluminosilicate IV and alumina slurry A, catalyst XV was prepared by following the procedure of (3) of Example 1.

The iron-containing crystalline aluminosilicate prepared during the present procedure was tested for various physical properties and the catalyst was rated for hydrocracking activity as follows.

### (I) Physical properties of iron-containing crystalline aluminosilicate

(a) Determination of TPR

The iron-containing crystalline aluminosilicate obtained as described above was dried and unified in particle diameter was placed in a quartz glass tube, 100 mg in inner volume, and calcined therein in a stream of dry air at 377° C. for two hours. The resultant calcine was cooled to room temperature and left standing in a stream of a mixed gas of hydrogen and argon for several hours. Then, it was heated to 1077° C. at a temperature increasing rate of 10° C./minute and tested meanwhile for mass balance of hydrogen. The amount of hydrogen was measured with a thermal conductivity tester (TCD). The [Fe] dep and the temperature of the reduction peak on the high temperature side obtained herein are shown in Table 1.

(b) Determination of lattice constant [UD]

A mixture obtained by thoroughly mixing and pulverizing a dry sample of the iron-containing crystalline aluminosilicate obtained as described above and the inner standard powder of silicon was placed in a sample holder for an X-ray powder diffraction device. It was analyzed by step scanning with a Cu bulb under the conditions of 40 KV of applied voltage and 40 mV of applied current. The lattice constant [UD] of the iron-containing crystalline aluminosilicate was calculated from the peak angle obtained by the diffraction analysis. The results are shown in Table 1.

(c) Determination of terminal SiOH group/Brønsted acid ratio

A wafer, 20 mm in diameter, formed of 30 mg of a dried powdery sample was deprived of physically adsorbed water by a heat treatment performed under a pressure not greater than 1.0×10⁻⁴ mmHg at 450° C. for one hour, cooled to room temperature, and dispersed into a spectrum by the transmission method using an infrared spectrophotometer. Then, from the IR spectrum consequently obtained, the absorbance C at 3740±10 cm⁻¹, the absorbance D at 3830±10 cm⁻¹, and the absorbance E at 3560±10 cm⁻¹ were calculated. The magnitudes thus obtained were standardized by being divided by the actual weight of the wafer. Let C′, D′, and E′ stand for the standardized magnitudes of absorbance, and the terminal SiOH group/Brønsted acid ratio will be found from the formula, C′/(D′+E′). The results are shown in Table 1.

### (II) Evaluation of catalyst for hydrocracking activity on residual oil

(Result of evaluation 1, independent catalyst evaluation)

In a high-pressure fixed bed reactor, 100 cc of molded pellets of a given catalyst were placed, subjected to a sulfiding, and used for performing a hydrocracking treatment on Arabian heavy atmospheric residual oil as the feed oil under the conditions of 400° C. of reaction temperature, 0.3 h⁻¹ of liquid hourly space velocity (LHSV), 135 kg/cm² of hydrogen partial pressure, and 1,000 nm³/kl of hydrogen/oil ratio. The oil consequently produced was analyzed by distillation gas chromatography to find the ratio of cracking of a 343⁺° C. fraction (fraction obtained at temperatures not lower than 343° C.), the yield of an middle distillate (fractions at 171-343° C.), and the ratio of desulfurization. By this procedure, the catalysts I, II, XIII, XIV, VI, and VII were evaluated for hydrocracking activity on atmospheric residue. The properties of the atmospheric residue as feed oil are shown in Table 2 and the results of evaluation obtained for the catalysts I, II, XIII, XIV, VI, and VII are shown in Table 3.

As compared with the catalyst I having an iron-containing crystalline aluminosilicate content of 65 wt. %, the catalyst II enjoyed an improved yield of an middle distillate owing to the decrease of the content to 60 wt. %. Also as respects the desulfurizing activity, the catalyst II enjoyed an increase of about 4 wt. % in consequence of an increase in the alumina content. By using this highly active iron-containing crystalline aluminosilicate as a catalyst component, it is made possible to decrease the crystalline aluminosilicate content, increase the alumina content, and improve the yield of an middle distillate. This aluminosilicate also permits a decrease in the cost of catalyst

(Result of evaluation 2: Combined catalysts evaluation)

In the high-pressure fixed bed reactor, 480 CC of a commercially available hydrodemetallizing catalyst formed of pellets of a trilobe, 1/16 inch in size, (nickel and molybdenum catalyst supported on alumina) (made by Catalysts & Chemical Industries Co., Ltd. and sold under the product code of “CDS-DM5”), 400 CC of a hydrodesulfurizing catalyst formed of pellets of trilobe, 1/16 inch in size, (cobalt and molybdenum catalyst supported on alumina) ((made by Catalysts & Chemical Industries Co., Ltd. and sold under the product code of “CDS-R25H”), 560 CC of the catalyst prepared as described above, and 560 CC of the hydrodesulfurizing catalyst mentioned above were sequentially placed in the order mentioned and subjected to a sulfiding by the standard method. Then, the catalysts were used to hydrocracking the atmospheric residue obtained from arabian light type crude oil. The catalysts I, II, XIII, and VI were evaluated for hydrocracking activity by following the procedure (evaluation 2: combined catalysts evaluation) mentioned above while using the conditions of 400° C. of reaction temperature, 0.25 of LHSV, 120 kg/cm² of hydrogen partial pressure, and 1,000 nm³/kl of hydrogen/oil ratio instead. The properties of the atmospheric reside as feed oil are shown in Table 4 and the results of evaluation obtained for the catalysts I, II, XIII, and VI are shown in Table 5.

(Result of evaluation 3: Combined catalysts evaluation)

The catalysts I, II, XIII, VI, and VII were evaluated for hydrocracking activity by following the procedure (evaluation 2: combined catalysts evaluation) mentioned above while using as the feed oil a mixed oil (formed of 60 volume % of a mixture of propane deasphalted asphalt and a vacuum residue and 40 volume % of light cycle oil) having the properties shown in Table 6. The results of evaluation obtained of the catalysts I, II, XIII, VI, and VII are shown in Table 7.

### (III) Evaluation of catalyst for hydrocracking activity on heavy distillate

(Result of evaluation 4: combined catalysts evaluation)

In the high-pressure fixed bed reactor, 50 CC of a commercially available hydrotreating catalyst formed of cylindrical pellets, 1/16 inch in size, (cobalt and molybdenum catalyst supported on alumina) (made by Catalysts & Chemical Industries Co., Ltd. and sold under the product code of “HT-D7”) and 50 CC of the catalyst prepared as described above were sequentially placed in the order mentioned and subjected to a sulfiding by the standard method. Then, they were used to hydrocracking an heavy gas oil I obtained from a Middle East crude oil under the conditions of 1.0 h⁻¹ of liquid hourly space velocity (LHSV), 110 kg/cm² of hydrogen partial pressure, and 1,000 nm²/kl of hydrogen/oil ratio. The reaction temperature was adjusted to 385° C. The properties of the heavy gas oil I as feed oil are shown in Table 8. The results of evaluation obtained for the catalysts IV, V, VIII, and IX are shown in Table 9.

(Result of evaluation 5: combined catalysts evaluation) The catalysts X, XI, and XII were evaluated by following the procedure (result of evaluation 4: combined catalysts evaluation) mentioned above while using a heavy gas oil II whose properties are shown in Table 8 instead. The results of evaluation obtained for the catalysts X, XI, and XII are shown in Table 10.

(Result of evaluation 6: combined catalyst evaluation)

In the high pressure fixed bed reactor, 50 CC of a commercially available hydrotreating catalyst formed of cylindrical pellets, 1/16 inch in size, (cobalt and molybdenum catalyst supported on alumina) (made by Catalysts & Chemical Industries Co., Ltd. and sold under the product code of “HT-D7”), 40 CC of the catalyst prepared as described above, and 10 CC of the hydrotreating catalyst mentioned above were placed sequentially in the order mentioned and used to effect a hydrocracking by following the procedure (evaluation 4: combined catalyst evaluation) mentioned above while adjusting the reaction temperature such that the ratio of cracking of a fraction at temperatures of not lower than 360° C. would fall at 65%. The results of evaluation obtained for the catalysts IV, V, VIII, and IX are shown in Table 11.

(Result of evaluation 7: combined catalysts evaluation)

The catalysts X, XI, and XII were evaluated by following the procedure of (result of evaluation 6: combined catalysts evaluation) mentioned above while using an heavy gas oil II whose properties are shown in Table 8 instead. The results of evaluation obtained for the catalysts X, XI, and XII are shown in Table 12.

(Result of evaluation 8: independent catalyst evaluation)

In the high pressure fixed bed reactor, 100 CC of the catalyst IV prepared as described above was placed and subjected to a sulfiding by the standard method. Then, the catalyst was used to perform a hydrocracking on the heavy gas oil I mentioned above as the feed oil under the conditions of 385° C. of reaction temperature, 1.0 hr⁻¹ of liquid hourly space velocity (LHSV), 110 kg/cm² of hydrogen partial pressure, and 1,000 nm³/kl of hydrogen/oil ratio. The results of evaluation obtained for the catalyst IV are shown in Table 13.

(Result of evaluation 9: combined catalysts evaluation)

In the high pressure fixed bed reactor, 50 CC of a commercially available hydrotreating catalyst formed of cylindrical pellets, 1/16 inch in size, (cobalt and molybdenum catalyst supported on alumina) (made by Catalysts & Chemical Industries Co., Ltd. and sold under the product code of “HT-D7”), 40 CC of the catalyst prepared as described above, and 10 CC of the hydrotreating catalyst mentioned above were sequentially placed in the order mentioned and used to effect a hydrocracking by following the procedure of (evaluation 4: combined catalysts evaluation) mentioned above while setting the reaction temperature at 390° C., using the heavy gas oil II as the feed oil, and adjusting the hydrogen partial pressure to 80 kg/cm² and 50 kg/cm². The results of evaluation for activity under each of the partial pressures of hydrogen are shown in Table 14.

TABLE 1
Physical properties of iron-containing
crystalline aluminosilicate

| Kind of formed iron | | | | |
|---|---|---|---|---|
| containing crystalline | | | | |
| aluminosilicate | I | II | III | IV |
| Mol ratio | | | | |
| Fe₂O₃/SiO₂ | 0.015 | 0.021 | 0.038 | 0.018 |
| SiO₂/Al₂O₃ | 37 | 44 | 17 | 38 |
| Lattice constant ( ) | 24.30 | 24.31 | 24.35 | 24.28 |
| TPR | | | | |
| [Fe] dep (%) | 5.9 | 21.3 | 30.0 | 34.0 |
| Peak temperature (° C.) on | | | | |
| higher temperature side | 1062 | 1010 | 949 | 1058 |
| (−300 × UD + 3820) value (° C.) | 1030 | 1027 | 1015 | 1036 |
| IR | 1.25 | 0.90 | 0.82 | 0.76 |
| Terminal SiOH group/B acid | | | | |
| ratio | | | | |

TABLE 2
Properties of Arabian heavy atmospheric residue

| | | Arabian heavy | |
|---|---|---|---|
| | | atmospheric | Method of |
| Item | | residue | determination |
| Density (15° C., g/cm³) | | 0.980 | JIS K-2248 |
| Sulfur content (wt. %) | | 4.2 | JIS K-2541 |
| Nitrogen content (ppm by weight) | | 2420 | JIS K-2606 |
| Vanadium (ppm by weight) | | 87 | JPI-5S-11-79 |
| Nickel (ppm by weight) | | 30 | JPI-5S-10-79 |
| Distillation | Fractions distilling | 95 | JIS K-2254 |
| | at temperatures of not | | |
| | lower than 343° C. | | |
| | (wt. %) | | |

TABLE 3
Result of evaluation 1

| | | | | | Comparative | Comparative | Comparative |
|---|---|---|---|---|---|---|---|
| Method of preparation of catalyst | Example 1 | Example 2 | Example 9 | Example 10 | example 1 | example 2 | example 5 |
| Kind of catalyst | I | II | XIII | XIV | VI | VII | XV |
| Cracking ratios of fractions | 60 | 55 | 50 | 55 | 45 | 33 | 37 |
| distilling at temperatures of not | | | | | | | |
| lower than 343° C. (wt. %) | | | | | | | |
| Yield of middle distillate (wt. %) | 15 | 21 | 27 | 22 | 20 | 20 | 17 |
| Ratio of desulfurization (wt. %) | 78 | 82 | 85 | 85 | 78 | 77 | 76 |

(Middle distillate: Fractions distilling at 171-343° C.)

TABLE 4
Properties of Arabian light atmospheric residue

| | | Arabian heavy | |
|---|---|---|---|
| | | atmospheric | Method of |
| Item | | residue | determination |
| Density (15° C., g/cm³) | | 0.960 | JIS K-2248 |
| Sulfur content (wt. %) | | 3.5 | JIS K-2541 |
| Nitrogen content (ppm by weight) | | 1840 | JIS K-2606 |
| Vanadium (ppm by weight) | | 38 | JPI-5S-11-79 |
| Nickel (ppm by weight) | | 11 | JPI-5S-10-79 |
| Distillation | Fractions distilling | 94 | JIS K-2254 |
| | at temperatures of not | | |
| | lower than 343° C. | | |
| | (wt. %) | | |

TABLE 5
Result of evaluation 2

| Method of | Ex- | Ex- | Ex- | Comparative |
|---|---|---|---|---|
| preparation of catalyst | ample 1 | ample 2 | ample 9 | Example 1 |
| Kind of catalyst | I | II | XIII | VI |
| Cracking ratios of fractions | 41 | 38 | 36 | 35 |
| distilling at | | | | |
| temperatures of not | | | | |
| lower than 343° C. (wt. %) | | | | |
| Yield of middle | 25 | 25 | 26 | 24 |
| distillate (wt. %) | | | | |
| Ratio of desulfurization | 98 | 98 | 98 | 98 |
| (wt. %) | | | | |

(Middle distillate: Fractions distilling at 171-343° C.)

TABLE 6
Properties of mixed oil

| | | | Method of |
|---|---|---|---|
| Item | | Mixed oil | determination |
| Density (15° C., g/cm³) | | 0.985 | JIS K-2248 |
| Viscosity (50° C., mm²/sec) | | 1000 | JIS K-2283 |
| Sulfur content (wt. %) | | 3.9 | JIS K-2541 |
| Nitrogen content (ppm by weight) | | 2500 | JIS K-2606 |
| Vanadium (ppm by weight) | | 77 | JPI-5S-11-79 |
| Nickel (ppm by weight) | | 25 | JPI-5S-10-79 |
| Distillation | Fractions distilling | 81 | JIS K-2254 |
| | at temperatures of not | | |
| | lower than 343° C. | | |
| | (wt. %) | | |

TABLE 7
Result of evaluation 3

| Method of | Ex- | Ex- | Ex- | Comparative |
|---|---|---|---|---|
| preparation of catalyst | ample 1 | ample 2 | ample 9 | Example 1 |
| Kind of catalyst | I | II | XIII | VI |
| Cracking ratios of fractions | 35 | 33 | 32 | 31 |
| distilling at temperatures of | | | | |
| not lower than | | | | |
| 343° C. (wt. %) | | | | |
| Yield of middle | 29 | 28 | 28 | 27 |
| distillate (wt. %) | | | | |
| Ratio of desulfurization | 90 | 91 | 92 | 90 |
| (wt. %) | | | | |

(Middle distillate: Fractions distilling at 171-343° C.)

TABLE 8
Properties of Heavy gas oil

| | | Heavy gas | Heavy gas | Method of |
|---|---|---|---|---|
| Item | | oil I | oil II | determination |
| Density (15° C., g/cm³) | | 0.906 | 0.925 | JIS K-2248 |
| Sulfur content (wt. %) | | 2.63 | 2.70 | JIS K-2541 |
| Nitrogen content | | 590 | 750 | JIS K-2606 |
| (ppm by weight) | | | | |
| Carbon residue (wt. %) | | 0.06 | 0.5 | JIS k-2270 |
| Kinematic Viscosity | | 16 | 35 | JIS K-2283 |
| (50° C. mm²/sec) | | | | |
| Distillation | Fractions | 82 | 88 | JIS K-2254 |
| | distilling | | | |
| | at temperatures | | | |
| | of not lower than | | | |
| | 343° C. (wt. %) | | | |

TABLE 9
Result of evaluation 4

| Method of | Ex- | Ex- | Comparative | Comparative |
|---|---|---|---|---|
| preparation of catalyst | ample 4 | ample 5 | Example 3 | Example 4 |
| Kind of catalyst | IV | V | VIII | IX |
| Reaction | 385 | 385 | 385 | 385 |
| temperature (° C.) | | | | |
| Cracking ratios of | 70 | 68 | 65 | 60 |
| fractions distilling at | | | | |
| temperatures of not | | | | |
| lower than | | | | |
| 360° C. (wt. %) | | | | |
| Yield of middle | 55 | 55 | 53 | 51 |
| distillate (wt. %) | | | | |

(Middle distillate: Fractions distilling at 120-360° C.)

TABLE 10
Result of evaluation 5

| Method of preparation of catalyst | Example 6 | Example 7 | Example 8 |
|---|---|---|---|
| Kind of catalyst | X | XI | XII |
| Reaction temperature (° C.) | 385 | 385 | 385 |
| Cracking ratios of fractions | 45 | 50 | 45 |
| distilling at temperatures of not | | | |
| lower than 360° C. (wt. %) | | | |
| Yield of middle distillate (wt. %) | 41 | 44 | 41 |

(Middle distillate: Fractions distilling at 120-360° C.)

TABLE 11
Result of evaluation 6

| | | | Comparative | Comparative |
|---|---|---|---|---|
| Method of preparation of catalyst | Example 4 | Example 5 | Example 3 | Example 4 |
| Kind of catalyst | IV | V | VIII | IX |
| Reaction temperature (° C.) | 387 | 388 | 390 | 395 |
| Cracking ratios of fractions | 65 | 65 | 65 | 65 |
| distilling at temperatures of not | | | | |
| lower than 360° C. (wt. %) | | | | |
| Yield of middle distillate (wt. %) | 51 | 52 | 51 | 53 |

(Middle distillate: Fractions distilling at 120-360° C.)

TABLE 12
Result of evaluation 7

| Method of preparation of catalyst | Example 6 | Example 7 | Example 8 |
|---|---|---|---|
| Kind of catalyst | X | XI | XII |
| Reaction temperature (° C.) | 395 | 392 | 390 |
| Cracking ratios of fractions | 65 | 65 | 65 |
| distilling at temperatures of not | | | |
| lower than 360° C. (wt. %) | | | |
| Yield of middle distillate (wt. %) | 52 | 51 | 51 |

(Middle distillate: Fractions distilling at 120-360° C.)

TABLE 13
Result of evaluation 8

| Method of preparation of catalyst | Example 4 |
|---|---|
| Kind of catalyst | IV |
| Reaction temperature (° C.) | 385 |
| Cracking ratios of fractions | 35 |
| distilling at temperatures of not | |
| lower than 360° C. (wt. %) | |
| Yield of middle distillate (wt. %) | 39 |

(Middle distillate: Fractions distilling at 120-360° C.)

TABLE 14
Result of evaluation 9

| Method of preparation of catalyst | Example 7 | Example 7 |
|---|---|---|
| Kind of catalyst | XI | XI |
| Reaction pressure (Kg/cm²) | 80 | 50 |
| Reaction temperature (° C.) | 390 | 390 |
| Cracking ratios of fractions | 55 | 35 |
| distilling at temperatures of not | | |
| lower than 360° C. (wt. %) | | |
| Yield of middle distillate (wt. %) | 47 | 35 |

(Middle distillate: Fractions distilling at 120-360° C.)

The present invention, by using a novel iron-containing crystalline aluminosilicate as a component for a catalyst, enables various hydrocarbon oils including heavy oils such as residual oil, mixed heavy oil, and heavy gas oil in particular to be hydrocracked with high efficiency at no sacrifice of the yield of middle distillate. In the case of a heavy distillate, the catalyst produces highly satisfactory results even when it has a small iron-containing crystalline aluminosilicate content. It produces a satisfactory result also when it is used in combination with a desulfurizing catalyst.

What is claimed is:

1. A method for the production of an iron-containing aluminosilicate satisfying the following conditions:
(A) the main composition of said aluminosilicate expressed in the form, of oxides is represented by the formula
aFe₂O₃Al₃O₃.bSiO₂nH₂O
wherein n is a real number of 1 to 30 and a and b are real numbers satisfying the relations
15<b<100, 0.005<a/b<0.15];
(B) an inactive iron compounded content (Fe) dep calculated by a temperature program reduction is not more than 25%;
(C) a reduction peak temperature Th in at least one high temperature part is in the range
Th>(−300×UD+8320)° C.
wherein UD is the lattice constant of said iron-containing crystalline aluminosilicate and is a real number within the range of 24.20 to 24.40, comprising: subjecting a crystalline a aluminosilicate having a ratio of silica to alumina (molar ratio) of not less than 4.6 to a steaming treatment hereby obtaining steaming crystalline aluminosilicate having a crystallinity of at least 0.7, treating said steaming crystalline alumino-silicate with a mineral acid, and treating the resultant crystalline aluminosilicate with a sulfuric acid salt of iron in the presence of the mineral acid.

2. A method according to claim 1, wherein said mineral acid is sulfuric acid.

3. A hydrocracking catalyst for a hydrocarbon oil, having at least one of the metals of Groups 5, 8, 9, and 10 in the Periodic Table of the Elements supported on a carrier formed of 5-85 wt. % of an iron-containing crystalline aluminosilicate prepared in claim 1 and 95-15 wt. % of an inorganic oxide.

4. A catalyst according to claim 3, wherein said inorganic oxide is alumina and the metal supported on said carrier is molybdenum and nickel or cobalt.

5. A method for the production of a hydrocracking oil, which comprises subjecting a hydrocarbon of oil to a hydrocracking using a hydrocracking catalyst set forth in claim 3.

6. A method according to claim 5 wherein said hydrocarbon oil subjected to said hydrocracking is a residual oil.

7. A method according to claim 5 wherein said hydrocarbon oil subjected to said hydrocracking is an heavy distillate.
